(19) United States
(12) Patent Application Publication
(10) Pub. No.: US 2006/0218309 A1
(43) Pub. Date: Sep. 28, 2006

(54) Device for upgrading a firmware of a display apparatus

(76) Inventors: Jenn-Shoou Young, Miao-Li County (TW); Fu-Chu Tu, Miao-Li County (TW)

Correspondence Address: J.C. Patents, Inc., Suite 250, 4 Venture, Irvine, CA, 92618, US

(21) Appl. No.: 11/315,022

(22) Filed: Dec. 21, 2005

(30) Foreign Application Priority Data
Mar. 24, 2005 (TW) 94109059

(51) Int. Cl. G06F 3/00

(52) U.S. Cl. 710/8

(57) ABSTRACT

A device for upgrading a firmware of a display apparatus is provided. The device comprises a USB port, a USB control chip and a micro-controller. The USB port is adapted for connecting with a storage device providing upgrading data. The USB control chip is coupled to the USB port for controlling the transmission of the upgrading data from the storage device to at least one component of the display apparatus to be upgraded. The micro-controller is coupled to the USB chip and is adapted for reading the upgrading data from the storage device and allocating the upgrading data to the components.

### CROSS-REFERENCE TO RELATED APPLICATION

This application claims the priority benefit of Taiwan application serial no. 94109059, filed on Mar. 24, 2005. All disclosure of the Taiwan application is incorporated herein by reference.

### BACKGROUND OF THE INVENTION

1. Field of the Invention

The present invention relates to a device for upgrading a firmware of a display apparatus, and particularly to a device for upgrading a firmware of a display apparatus that can be upgraded via universal serial bus (USB) ports.

2. Description of Related Art

Referring to FIG. 1, a conventional television generally comprises a micro-controller 103, a scalar 104, and an optical engine 105. The micro-controller 103 controls all functions, the scalar 104 is adapted to zoom in/out images to match a resolution conventional of the television, and the optical engine 105 is adapted for displaying the images.

If a firmware of the conventional television needs to be upgraded, as shown in FIG. 1, a personal computer 101 is connecting with a RS232 port 102 of the conventional television via a RS232 cable, thereafter, a program of the personal computer 101 is executing via the RS232 port 102 to upgrade a firmware of the conventional television.

The foregoing upgrading method has several disadvantages. First, it increases a cost of customer service, since the software for upgrading is generally recorded in a hard disk or a compact disc and it is not easy for ordinary users to upgrade the television by themselves, and therefore a serviceman must be present for upgrading software via RS232 cable, sometimes the serviceman needs even to bring personal computers for upgrading the firmware. Second, it is only for upgrading micro-controllers 103 and scalar 104, and it is not adapted for upgrading chipsets of digital televisions. Moreover, the televisions are constantly developing to include more and more features and sophisticated structures, many of the new features can be added by upgrading the firmware thereof. It is much more user-friendly if users can upgrade the firmware by themselves.

### SUMMARY OF THE INVENTION

It is an object of the present invention to provide a device for upgrading a firmware of a display apparatus, by which the users can conveniently obtain the software and upgrade the display apparatus by themselves, thereby reducing the cost of customer service.

For achieving the foregoing object and others, the present invention provides a device for upgrading a firmware of a display apparatus, comprising a universal serial bus (USB) port, a USB control chip, and a micro-controller. The USB port is adapted for connecting with a storage device, which provides upgrading data. The USB control chip is coupled to the USB port, for controlling the transmission of upgrading data from the storage device to at least one component of the display apparatus to be upgraded. The micro-controller is coupled to the USB control chip to read the upgrading data from the storage device and allocate the upgrading data to the component. The USB control chip can be a USB slave device, and the storage device can be a host device, such as a personal computer. The USB control chip supports USB on-the-go (USB OTG). The foregoing USB control chip can also be a USB host device, and the storage device can be a slave device accordingly, such as a compact flash. The upgrading data includes at least one of firmware program code and extended display identification data (EDID).

The USB control chip supports USB OTG, and can be the USB host device or the USB slave device. When the USB control chip is the USB host device, it can be connected with the slave device such as a compact flash, to obtain the software for upgrading so that the display apparatus can be upgraded by the USB control chip. When the USB control chip is the USB slave device, it can be connected with the host device such as a personal computer, to obtain software for upgrading. There are many options for manufactures to deliver the software for upgrading to the users. For example, the manufactures can mail the compact flash, in which the software for upgrading are recorded, to the user. Then the user can conveniently upgrade the firmware by inserting the compact flash into the device for upgrading the firmware of the display apparatus of the present invention. The user can also download the software from a website of the manufacture by using the personal computer, and then the personal computer is connected with the device for upgrading the firmware of the display apparatus via the USB ports to upgrade the firmware. Thus, it is very convenient for the user to add new functions or debug the firmware of the display apparatus, and the cost of customer service can also be decreased.

The accompanying drawings are included to provide a further understanding of the invention, and are incorporated in and constitute a part of this specification. The drawings illustrate embodiments of the invention and, together with the description, serve to explain the principles of the invention.

### BRIEF DESCRIPTION OF THE DRAWINGS

FIG. 1 is a schematic diagram of upgrading a firmware of a conventional television.

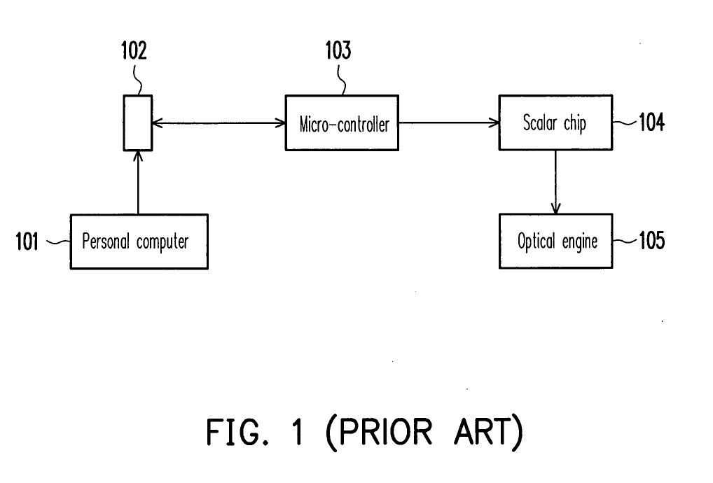

FIG. 2 is a schematic diagram of a device for upgrading a firmware of a display apparatus according to a first embodiment of the present invention.

FIG. 3 is a schematic diagram of a device for upgrading a firmware of a display apparatus according to a second embodiment of the present invention.

### DESCRIPTION OF THE EMBODIMENTS

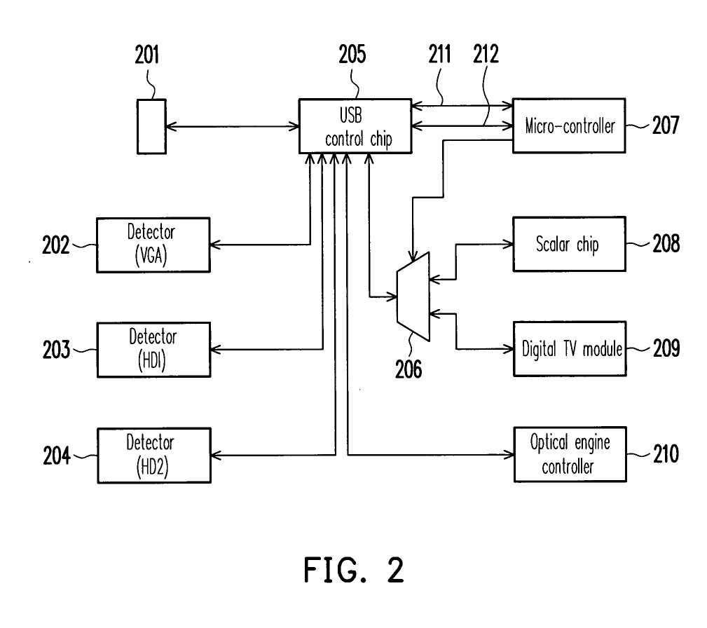

FIG. 2 is a schematic diagram of a device for upgrading a firmware of a display apparatus according to a first embodiment of the present invention. Referring to FIG. 2, the display apparatus of the embodiment has both functions of a digital television and a monitor. Generally, the detectors 202˜204 are adapted to detect resolutions of input signals. A micro-controller 207, a scalar 208, a digital television module 209 and an optical engine controller 210 are a core of the digital television.

A device for upgrading the firmware of the display apparatus of according to the embodiment includes a USB port 201, a USB control chip 205, and the micro-controller 207. The USB port 201 is adapted for connecting with a storage device (not shown) for providing upgrading data. The upgrading data refer to program codes or data required for upgrading the firmware, and the upgrading data comprises at least one upgrading file. The USB control chip 205 is coupled to the USB port 201 for controlling a transmission of the upgrading data from the storage device to at least one component of the display apparatus to be upgraded. The components are described in detail as following.

The micro-controller 207 is coupled to the USB control chip 205 for reading the upgrading data from the storage device and allocating the upgrading data to the component(s) needed to be upgraded. In this embodiment, the micro-controller 207 allocates the upgrading file(s) to the corresponding component(s) according to the file name(s) of the upgrading file(s). The micro-controller 207 and other component(s) are coupled to the USB control chip 205 via an inter-integrated circuit (I2C) bus 212. However, the connection is not limited to the I2C bus, and other connecting methods can also be used in the present invention. Furthermore, due to the frequent data transmission between the USB control chip 205 and the micro-controller 207, a control bus 211 is used to transfer the commands between the USB control chip 205 and the micro-controller 207 in the embodiment.

In this embodiment, the upgradeable components include detectors 202˜204, the scalar 208, the digital television module 209, and the optical engine controller 210. The detectors 202˜204 are coupled to the USB control chip 205 for detecting the display format(s), including the resolution, of the input signals according to the display data channel (DDC) standard and the EDID recorded. In the embodiment, the display formats corresponding to the detectors 202˜204 are respectively video graphic array (VGA), a high definition 1 (HD1), and a high definition 2 (HD2), wherein the detectors 202˜204 are upgraded by replacing the EDID recorded therein.

The optical engine controller 210 is coupled to the USB control chip 205 for controlling a displaying color of the display apparatus of the embodiment. The scalar 208 controls the zooming in/out of displayed images under different display formats. The digital television module 209 of the embodiment provides functions such as digital broadcasting, digital channels, programs grading, and digital closed caption. A converter 206 is coupled among the scalar 208, the digital television module 209, the micro-controller 207 and the USB control chip 205. According to instructions of the micro-controller 207, the converter 206 transfers the upgrading data provided by the USB control chip 205 to the scalar 208 or the digital television module 209. In the embodiment, the scalar 208 and the digital television module 209 can only provide RS232 interface, therefore the converter 206 is required to transmission between the interfaces of the 12C and the RS232 and switch the data paths to the scalar 208 and to the digital television module 209. In other embodiments of the present invention, if the scalar 208 and the digital television module 209 support the 12C bus, the scalar 208 and the digital television module 209 can be directly coupled to the USB control chip 205 without using the converter 206.

In addition to the foregoing components, the display apparatus according to the present invention further comprises a feedback device (not shown) for displaying a status and a process of upgrading the firmware. In the embodiment, the feedback device comprises, for example but not limited to, light-emitting diodes (LEDs).

The USB control chip 205 supports the portable USB OTG and can act as the USB slave device to connect with the host device, such as the personal computer. The USB control chip 205 also can act as the USB host device to connect with the slave device, such as the compact flash. Accordingly, the USB devices including the personal computers and compact flashes can be connected with the USB port 201, acting as the storage device of the embodiment.

There are many options for manufactures to deliver software for upgrading to the user. For example, when the USB control chip 205 acts as the USB host device to connect with the slave device, the manufactures can mail the compact flash, in which the software for upgrading are recorded, to the user. The user can conveniently upgrade the firmware by simply inserting the compact flash into the device for upgrading the firmware of the display apparatus of the present invention. When the USB control chip 205 acts as the USB slave device to connect with the host device, the user can download the software from a website of the manufacture by using the personal computer (host device), and then the personal computer is connected with the device for upgrading the firmware of the display apparatus via the USB ports to upgrade the firmware. Thus, it is very convenient for the user to add new functions or debug the firmware of the display apparatus of the present invention, and the cost of customer service can also be decreased.

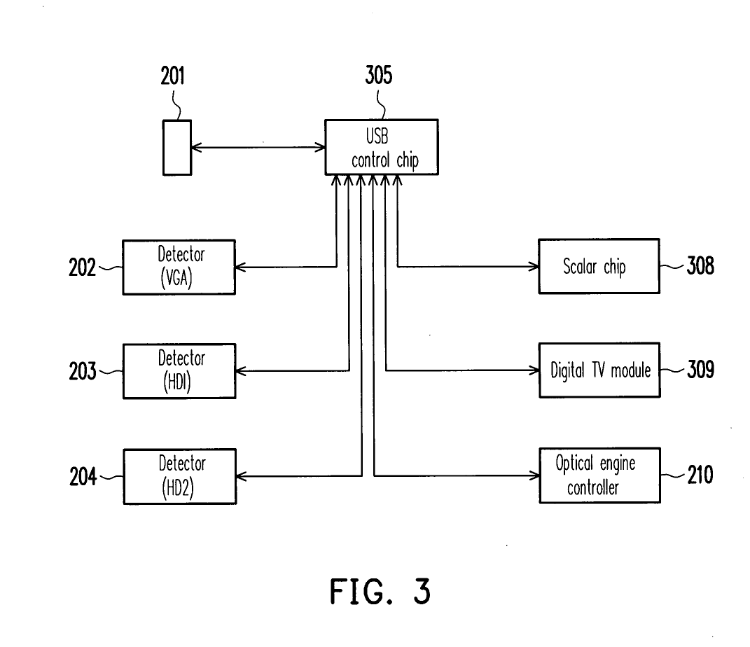

FIG. 3 is a schematic diagram of a device for upgrading a firmware of a display apparatus according to a second embodiment of the present invention. Referring to FIG. 3, the difference between the second embodiment of FIG. 3 and the first embodiment of FIG. 2 is that a USB control chip 305 as a host device controls the firmware upgrading instead of the micro-controller 207. Moreover, according to the second embodiment, a scalar 308 and a digital television module 309 as well as the other components are coupled to a USB control chip 305 via an 12C bus instead of the converter 206.

Other modifications and adaptations of the above-described embodiments of the present invention may be made to meet particular requirements. This disclosure is intended to exemplify the invention without limiting its scope. All modifications that incorporate the invention disclosed in the preferred embodiment are to be construed as coming within the scope of the appended claims or the range of equivalents to which the claims are entitled.

What is claimed is:

1. A device for upgrading a firmware of a display apparatus, comprising:
a universal serial bus (USB) port, adapted for connecting with a storage device providing an upgrading data;
a USB control chip, coupled to said USB port, controlling a transmission of said upgrading data from said storage device to at least one component of said display apparatus to be upgraded; and
a micro-controller, coupled to said USB control chip to read said upgrading data from said storage device and allocate said upgrading data to said component of said display apparatus to be upgraded.

2. The device according to claim 1, wherein said component is coupled to said USB control chip and is one of the group consisting of a detector, an optical engine controller, a scalar, and a digital television module, and said detector is adapted to detect a display format of input signals according to a display data channel standard and an extended display identification data recorded by said detector; said optical engine controller is adapted to control displaying colors of said display apparatus, said scalar is adapted to control the zooming in/out of displayed images under different display formats, and the digital television module is adapted to provide digital television functions of said display apparatus.

3. The device according to claim 2, wherein said display format is one of the group consisting of video graphic array, high definition 1, and high definition 2.

4. The device according to claim 2, further comprising a converter coupled among said scalar, said digital television module, said micro-controller and said USB control chip, wherein said converter transfers said upgrading data from said USB control chip to one of said scalar and said digital television module according to instructions from said micro-controller.

5. The device according to claim 1, further comprising a control bus for transferring commands between said USB control chip and said micro-controller.

6. The device according to claim 1, wherein said USB control chip is a USB slave device and said storage device is a host device.

7. The device according to claim 6, wherein said storage device is a personal computer.

8. The device according to claim 1, wherein said USB control chip supports USB on-the-go (OTG).

9. The device according to claim 8, wherein said USB control chip is a USB host device and said storage device is a slave device.

10. The device according to claim 1, wherein said upgrading data comprises at least one upgrading file and said micro-controller allocates said upgrading file to said corresponding component according to a file name of said upgrading file.

11. The device according to claim 1, wherein said upgrading data comprises at least one of firmware program code and extended display identification data.

12. The device according to claim 1, further comprising a feedback device, for displaying a status and a process of upgrading said firmware.

13. A device for upgrading a firmware of a display apparatus, comprising:
a USB port, adapted for connecting with a storage device providing a upgrading data; and
a USB control chip, coupled to said USB port, the USB control chip controlling a transmission of said upgrading data from said storage device to at least one component of said display apparatus to be upgraded.

14. The device according to claim 13, wherein said component to be upgraded is coupled to said USB control chip and is one of the group consisting of a detector, an optical engine controller, a scalar, and a digital television module, and said detector is adapted to detect a display format of input signals according to a display data channel standard and an extended display identification data recorded by said detector, and said optical engine controller is adapted to control displaying color of said display apparatus, said scalar is adapted to control the zooming in/out of displayed images under different display formats, and said digital television module is adapted to provide digital television functions of said display apparatus.

15. The device according to claim 13, further comprising a micro-controller, coupled to said USB control chip for reading said upgrading data from said storage device and allocating said upgrading data to said component of said display apparatus.

16. The device according to claim 13, wherein said USB control chip supports USB on-the-go (OTG).

17. The device according to claim 13, wherein said upgrading data comprises at least one upgrading file and said USB control chip allocates said upgrading file to said corresponding component according to a file name of said upgrading files.

18. The device according to claim 13, wherein said USB control chip allocates said upgrading file to said corresponding component.

19. The device according to claim 13, wherein said USB control chip is a USB host device and said storage device is a slave device.

20. The device according to claim 13, wherein said USB control chip is a USB slave device and said storage device is a personal computer.
